(19) United States
(12) Patent Application Publication
(10) Pub. No.: US 2018/0071984 A1
(43) Pub. Date: Mar. 15, 2018

(54) PRINTING APPARATUS FOR BUILDING THREE-DIMENSIONAL OBJECT

(71) Applicant: LG ELECTRONICS INC., Seoul (KR)

(72) Inventors: Sangyun LEE, Seoul (KR); Haiseong JEONG, Seoul (KR)

(21) Appl. No.: 15/559,216

(22) PCT Filed: Apr. 23, 2015
(86) PCT No.: PCT/KR2015/004052

§ 371 Date: Sep. 18, 2017

(30) Foreign Application Priority Data
Mar. 16, 2015 (KR) 10-2015-0036178

(51) Int. Cl. B29C 64/314; B29C 64/336; B29C 64/35; B33Y 30/00; B33Y 40/00; B01F 13/10; B01F 5/10; B01F 3/08; B01F 15/00

(52) U.S. Cl. CPC B29C 64/314; B29C 64/336; B29C 64/35; B33Y 30/00; B41J 2/01; B01F 13/1055; B01F 5/108; B01F 3/0853; B01F 15/00025; B33Y 40/00

(57) ABSTRACT

A 3D printing apparatus is provided. The 3D printing apparatus includes a plurality of source tanks in which gel-phase source inks having specific colors are respectively stored; a build tray on which a building object to be printed is layered; a head unit including a plurality of printing heads to spray the source inks onto the build tray; a mixing tank disposed on an ink passage between the source tanks and the head unit to mix the source inks supplied from the plurality of source tanks; a first supply tube connecting each of the plurality of source tanks to the mixing tank; and a second supply tube connecting the mixing tank to the head unit.

### TECHNICAL FIELD

The present disclosure relates to a printing apparatus for building a three-dimensional (3D) object.

### BACKGROUND ART

3D printing technologies that have recently started to receive attention have enhanced in degree of freedom with respect to a configuration of a product because a mold required in a typical mass production manner is not necessary at all, and also constraint conditions needed for molding the product in the mold are removed. For example, when a product is produced by using injection molding, in order to extract the product from a mold, the product needs to have no undercut and have a predetermined draft angle. Also, a spatially complicated shape of the product is one of limitations that may not be achieved by the mold.

However, the 3D printing technologies may enable a component, which has a shape that is impossible to be molded in the mass production manner using the mold, to be molded and also mold a component even in an assembled state. Thus, components having various conditions may be built.

Like this, the 3D printing technologies have brought radical change in approach to the shape of the product and production of the product to almost resolve difficulties when manufacturing a mock-up or prototype.

The 3D printing technologies may be classified into a photocuring process, a sintering process, a fused deposition modeling (FDM) manner, a color jetting printing manner, a multi jetting printing or polyjet manner in which the photocuring process is mixed with the color jetting printing manner, and a thin film laminating manner (LOM, PLT, PSL) according to the processes.

Also, sources used for the 3D printing technologies may be classified into a solid phase, a liquid phase, and a powder type according to phases of the sources. In detail, the solid phase source is mainly used for the FDM printing apparatus. Poly lactic acid (PLA), acrylonitrile-butadiene-styrene (ABS) resin, and styrene which are thermo-plastic resins are used as main materials of the solid phase source and are processed in a filament form.

Also, the liquid phase source is a gel type source and mainly used for the photocuring process. The powder type source is used for a printing apparatus using a selective laser sintering (SLS) manner that is one of a sintering manner. Here, powder type polymer or a metal source sintered by a laser is a main material of the powder type source.

FIG. 1 is a system view illustrating an ink supply structure of a color jetting 3D printing apparatus or a polyget 3D printing apparatus according to a related art.

Referring to FIG. 1, the 3D color printing apparatus includes a plurality of source tanks 3 in which inks having various colors are filled, a plurality of supply pump respectively connected to the plurality of source tanks 3 to discharge the source ink, a plurality of auxiliary tank 2 respectively connected to the plurality of supply pump 4, and a head unit 1 connected to the plurality of auxiliary tanks 2.

In detail, the head unit 1 includes a plurality of printing heads 1a, 1b, and 1c. Each of the plurality of auxiliary tanks 2 is connected to one or the plurality of printing heads 1a, 1b, and 1c. Also, one printing head is connected to one auxiliary tank.

Thus, to layer and print a building object by spraying a color in which two or more inks are mixed with each other, only the printing head connected to the source tank of the corresponding color operates, and other printing heads do not operate. That is, an ink may be sprayed from only a nozzle of the printing head connected to the source tank that is needed to generate a specific color, but not be sprayed from nozzles of other printing heads.

Thus, even though the head unit is constituted by the plurality of printing heads, all of the printing heads constituting the head unit are not involved in the printing work, and thus a printing speed is delayed.

Also, the ink attached to the nozzle of the printing heads in a resting state may be hardened or solidified to block the nozzle.

Also, frequency of use of the plurality of printing heads may vary according to amounts of the colors expressed on the building object. Thus, lifecycles of the printing heads may be difficult from each other. As a result, even though a portion of the printing heads normally operates, the head unit has to be frequently replaced due to a printing head required to be replaced.

### DISCLOSURE OF INVENTION

### Technical Problem

The present disclosure has been proposed to improve the above-described limitations.

### Solution to Problem

In one embodiment, a 3D printing apparatus includes: a plurality of source tanks in which gel-phase source inks having specific colors are respectively stored; a build tray on which a building object to be printed is layered; a head unit including a plurality of printing heads to spray the source inks onto the build tray; a mixing tank disposed on an ink passage between the source tanks and the head unit to mix the source inks supplied from the plurality of source tanks; a first supply tube connecting each of the plurality of source tanks to the mixing tank; and a second supply tube connecting the mixing tank to the head unit.

### ADVANTAGEOUS EFFECTS OF INVENTION

There are following effects according to the 3D printing apparatus having the above described constitutions according to embodiments.

First, since the plurality of printing heads constituting the head unit are simultaneously involved in the printing process, the 3D printing apparatus may increase in printing speed when compared to the 3D inkjet printing apparatus according to the related art.

Second, since all of the printing heads constituting the head unit are simultaneously used and stopped, a phenomenon in which the nozzle of the specific printing head is blocked or hardened may be prevented.

Third, since the lifespans of all of the printing heads constituting the head unit are uniformly maintained, the head unit may increase in replacement period when compared to the 3D inkjet printing apparatus according to the related art.

### BRIEF DESCRIPTION OF DRAWINGS

FIG. 1 is a system view illustrating an ink supply structure of a color jetting 3D printing apparatus or a polyget 3D printing apparatus according to a related art.

FIG. 2 is a perspective view illustrating an outer appearance of a 3D printing apparatus according to an embodiment.

FIG. 3 is a view for explaining an operation principle of the 3D printing apparatus according to an embodiment.

FIG. 4 is a view illustrating an ink mixing mechanism of the 3D printing apparatus according to an embodiment.

FIG. 5 is a perspective view of a mixing tank disposed in the 3D printing apparatus according to an embodiment.

FIG. 6 is a longitudinal-sectional view cut off along line VI-VI of FIG. 5.

FIG. 7 is a longitudinal-sectional view cut off along line VII-VII of FIG. 5.

FIG. 8 is a cross-sectional view cut off along line VIII-VIII of FIG. 5.

FIG. 9 is a view illustrating the ink mixing mechanism of the 3D printing apparatus according to an embodiment.

FIG. 10 is a view illustrating an ink mixing mechanism including a mixing tank according to another embodiment.

FIG. 11 is a cross-sectional view cut off along line XI-XI of FIG. 10.

FIG. 12 is a flowchart showing a mixing tank cleaning process for changing an ink color in the mixing tank.

### MODE FOR THE INVENTION

Reference will now be made in detail to the embodiments of the present disclosure, examples of which are illustrated in the accompanying drawings.

Hereinafter, a three-dimensional (3D) printing apparatus according to embodiments will be described in detail with reference to the accompanying drawings.

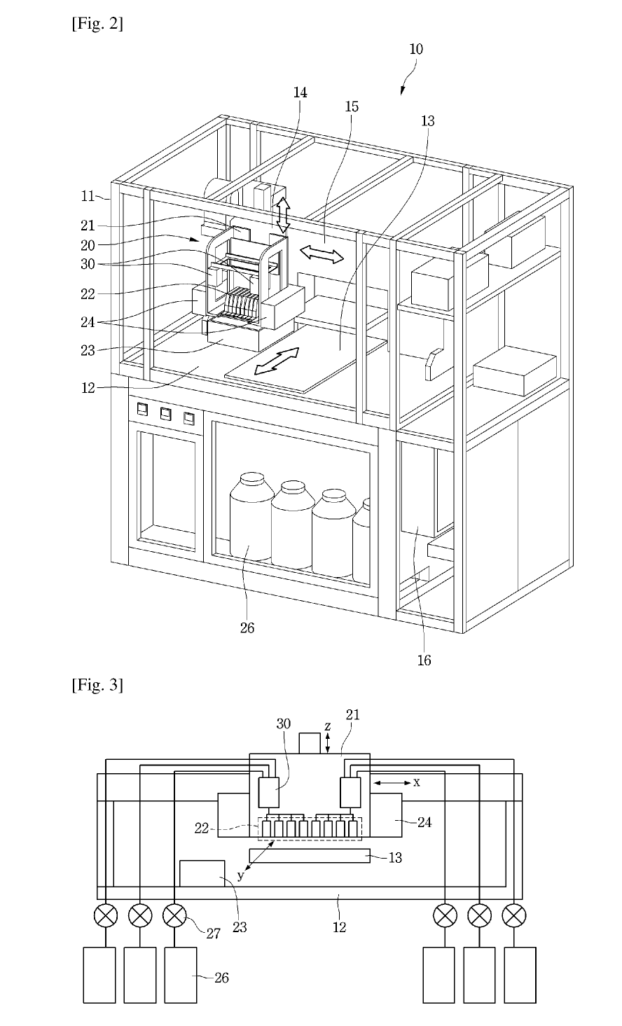

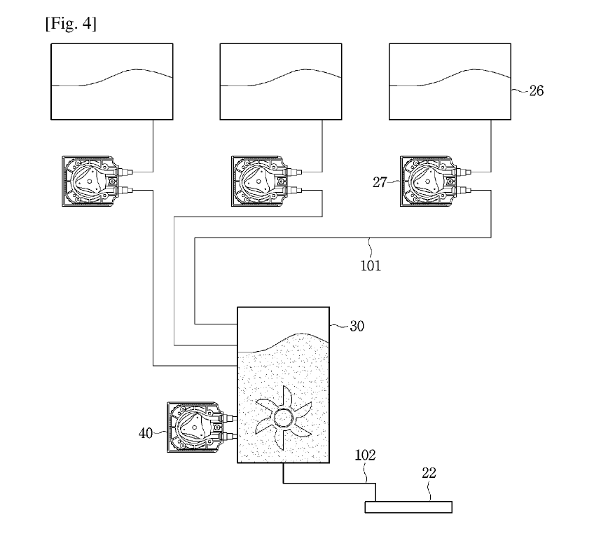

FIG. 2 is a perspective view illustrating an outer appearance of a 3D printing apparatus according to an embodiment, and FIG. 3 is a view for explaining an operation principle of the 3D printing apparatus according to an embodiment.

Referring to FIGS. 2 and 3, a 3D printing apparatus 10 according to an embodiment may include a frame 11 defining an outer appearance, a base plate 12 vertically partitioning the frame 11, a build tray 13 moving on the base plate 12 in a front/rear (y-axis) direction of the 3D printing apparatus and on which an object to be three-dimensionally printed (hereinafter, referred to as a building object) is layered, a printing module 20 layering the building object on the build tray 13 while moving above the base plate 120 in a left/right (x-axis) direction and vertical (z-axis) direction of the 3D printing apparatus, a plurality of source tanks 26 accommodated in a space defined below the base plate 12, and a control box 16 controlling an overall operation of the 3D printing apparatus 10 including an operation of the printing module 20.

Here, the printing module 20 may be movable in the x-axis and z-axis directions by an x-axis moving guide part 15 and a z-axis moving guide part 14.

The printing module 20 may include a head carriage 21 connected to the x-axis moving guide part 15 and the z-axis moving guide part 14, a head unit 22 mounted on an inner bottom surface of the head carriage 21, a mixing tank 30 mounted above the head unit 22 inside the head carriage 21, a curing lamp 24 mounted on each of left and right sides of the head unit 22, and a maintenance unit 23 placed on the base plate 12 below the head carriage 21.

In detail, the head unit 22 may be provided as one module in which a plurality of printing heads are arranged in the x-axis direction. A plurality of nozzles are arranged in a longitudinal direction of the printing heads on bottom surfaces of the printing heads constituting the head unit 22, respectively. Here, the head unit 22 may have the same structure as a printing head mounted on an existing 2D inkjet printer except for a kind of source sprayed through the nozzles and a configuration thereof.

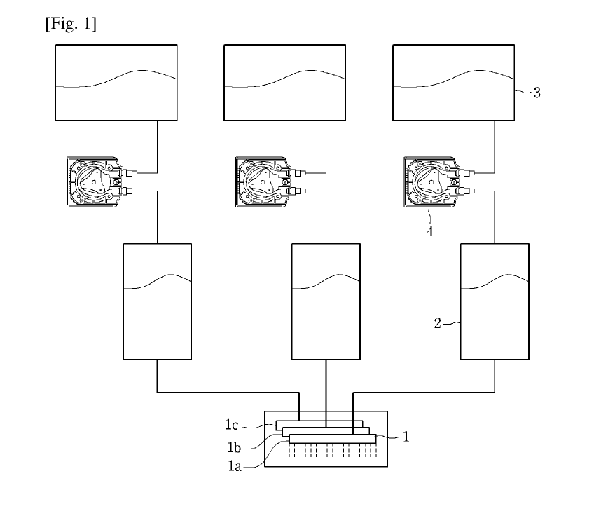

If the 3D building object is a color solid, the mixing tank 30 may be used as a unit for mixing a plurality of color inks. That is, inks having colors different from each other, which are respectively supplied into the plurality of source tanks 26, may be supplied into the mixing tank 30 and then mixed with each other to generate a desired color. Also, the ink having a new color, which is generated in the mixing tank 30, may be sprayed to the plurality of printing heads constituting the head unit 22. Although the plurality of mixing tanks 23 are mounted inside the head carriage 21 as illustrated in FIGS. 1 and 2, the present disclosure is not limited thereto. For example, a single mixing tank 30 may be provided. An agitator for mixing the inks supplied from the plurality of source tanks 26 may be mounted inside the mixing tank 30. Also, a supply pump 27 may be mounted between the source tank 26 and the mixing tank 30 to allow the colored ink stored in the source tank 26 to be smoothly supplied into the mixing tank 30. Also, two or more mixing tanks 30 may be disposed as illustrated, but the present disclosure is not limited thereto. For example, a single mixing tank 30 having a relatively large size may be disposed.

The curing lamp 24 may be an ink curing unit for curing the ink sprayed from the nozzle of the head unit 22 by using ultraviolet (UV) light. Thus, UV light having a specific frequency may be irradiated onto a surface of the sprayed ink to cure the sprayed ink. Also, the curing lamp 24 may be mounted on each of left and right edges of the head unit 22. That is, the UV light irradiated from the curing lamp 24 disposed at the left side may cure the sprayed link while moving in the x-axis direction from the left side to the right side of the head unit 22. The UV light irradiated from the curing lamp 24 disposed at the right side may cure the sprayed link while moving in a ? X-axis direction from the right side to the left side of the head unit 22.

The maintenance unit 23 may operate when reaching a time period at which the nozzle of the head unit 22 has to be cleaned. The maintenance unit 23 cleanly wipes an ink residue attached to the nozzle of the head unit 22.

In the 3D printing apparatus 10 having the above-described structure, when a print start button is pushed by using a control panel, the head unit 22 moves in the x-axis direction and then is disposed above the build tray 23. Then, inks are supplied from the source tanks 26 to the mixing tank 30 according to a design drawing provided from a main computer to generate an ink having a predetermined color.

Also, the head unit 22 sprays the ink supplied from the mixing tank 30 to the build tray 13 while moving in ±x-axis and ±z-axis directions. Simultaneously, a desired 3D building object is layered on a top surface of the build tray 13 while the build tray 13 moves in a ±y-axis direction.

Also, the 3D printing apparatus 10 may be programmed so that the maintenance unit 23 operates after a power is applied to the printing apparatus 10 to become in a printing standby state, or the printing is completed or before an ink having a specific color is entirely sprayed, and thus an ink having a different color is replaced.

FIG. 4 is a view illustrating an ink mixing mechanism of the 3D printing apparatus according to an embodiment.

Referring to FIG. 4, as illustrated in FIG. 3, each of the plurality of source tanks 26 in which an ink having a specific color is filled is connected to the mixing tank 30 through a first supply tube 101. Also, the supply pump 27 may be connected to a portion of the first supply tube 101 to allow a source ink to be smoothly supplied from the source tank 26 into the mixing tank 30.

Also, a circulation pump 40 is disposed on one side of the mixing tank 30 to rapidly mix inks having various colors supplied from the source tanks 26 with each other.

Also, an ink having a new color mixed and generated in the mixing tank 30 is connected to the head unit 22 through a second supply tube 102. Also, the ink may be sprayed through the nozzles disposed on the plurality of printing heads constituting the head unit 22.

Hereinafter, constitutions of the mixing tank 30 will be described with reference to the drawings in detail.

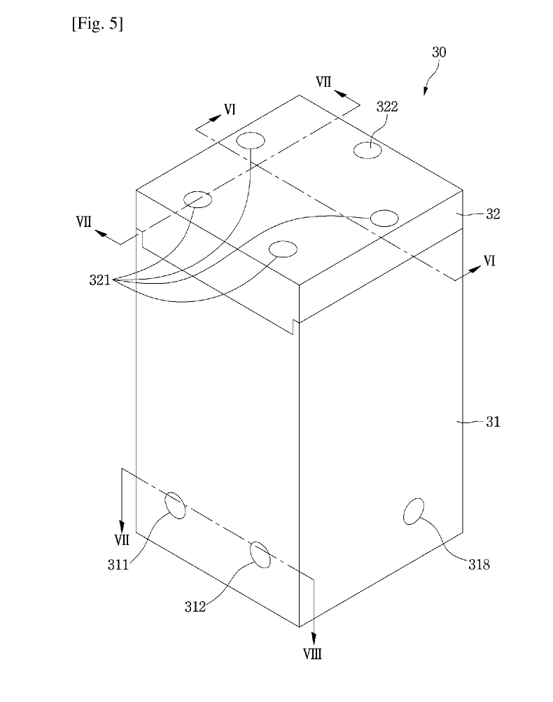

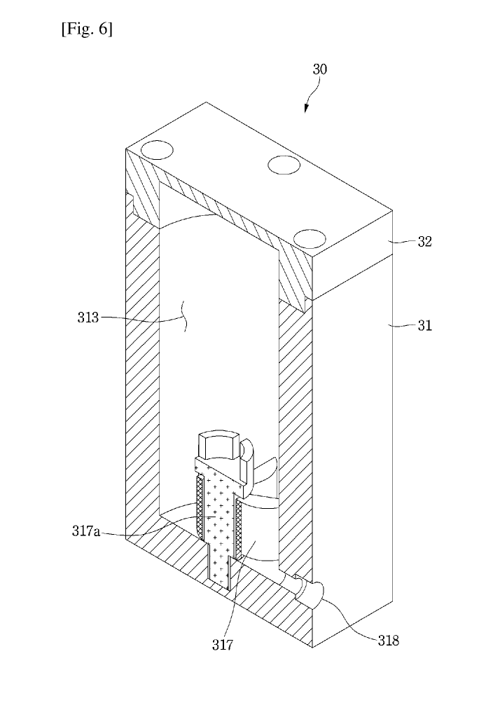

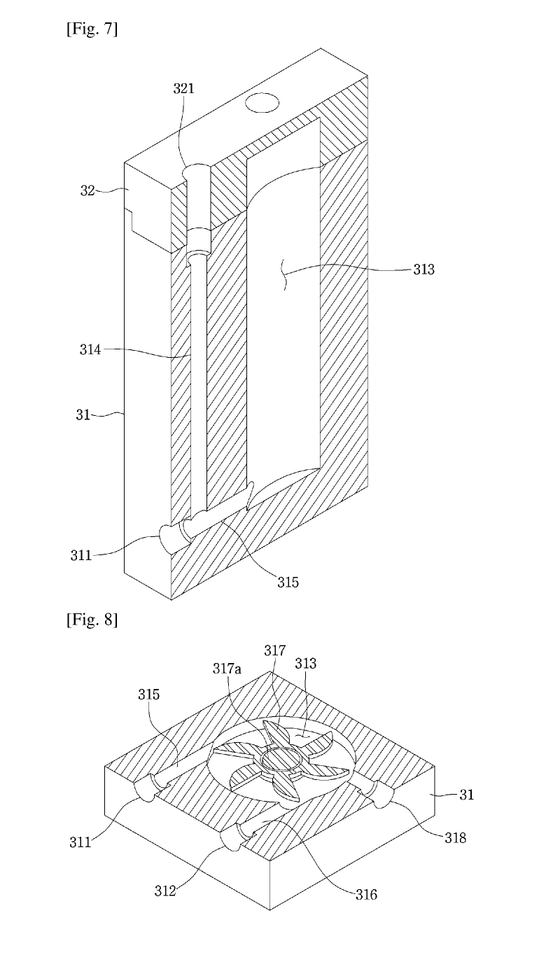

FIG. 5 is a perspective view of a mixing tank disposed in the 3D printing apparatus according to an embodiment, and FIG. 6 is a longitudinal-sectional view cut off along line VI-VI of FIG. 5, and FIG. 7 is a longitudinal-sectional view cut off along line VII-VII of FIG. 5, and FIG. 8 is a cross-sectional view cut off along line VIII-VIII of FIG. 5.

Referring to FIGS. 5 to 8, the mixing tank 30 according to an embodiment may include a tank body 31 in which a mixing chamber 313 is defined, a tank cover 32 covering a top surface of the tank body 31, and an agitator 317 accommodated into the mixing chamber to mix the ink.

In detail, a discharge port 311 for discharging the ink to the circulation pump 40 and a return port 312 for guiding the ink returning from the circulation pump 40 to the tank body 31 into the mixing chamber 313 are disposed on one side surface of the tank body 31.

Also, a plurality of supply passages 314 may extend in a length direction of the tank body 31 in the inside of the tank body 31 corresponding to between an outer circumferential surface of the tank body 31 and the mixing chamber 313. Each of the plurality of supply passages 314 has an end that communicates with the mixing chamber 313. For example, the supply passage 314 may be an L-shaped passage of which a curved portion is smoothly rounded.

Also, a discharge passage 315 through which the discharge port 311 is connected to the mixing chamber 313 and a return passage 316 through which the return port 312 is connected to the mixing chamber 313 may horizontally extend. Also, a portion of the plurality of supply passages 314 may vertically extend. Here, a lower end of the supply passage 314 may be connected to the discharge passage or the return passage 316.

Also, an outlet port 318 is disposed on the other one side surface of the tank body 31 to communicate with a lower end of the mixing chamber 313.

Also, the agitator 317 may be rotatably connected with respect to an agitating shaft 317a in the tank body 31. The agitating shaft 317a may be connected to an agitating motor (not shown). The agitating motor may be disposed on a center of a bottom surface of the tank body 31. A motor shaft may pass through the bottom surface of the tank body 31 and thus be connected to the agitating shaft 317a. Also, the agitator 317 may be provided with various types of agitator as well as a propeller type agitator.

Also, a plurality of source supply ports 321 having the number corresponding to that of the source tanks and a cleaning solution supply port 322 are disposed on an upper portion of the tank body 31. Also, the plurality of source supply ports 321 and the cleaning solution supply port 322 may communicate with the supply passages 314 defined in the tank body 31, respectively. Thus, the source ink and a cleaning solution introduced into the supply ports 321 and 322 may be guided into the mixing chamber 313 through the supply passages 314.

Here, the supply ports 321 and 322 may not be disposed on a top surface of the mixing chamber 313 but be disposed in a position laterally spaced apart from the mixing chamber 313 to allow the ink to be guided into the mixing chamber 313 through a separate supply passage 314. This is done because to minimize generation of air bubbles when the ink is supplied.

In detail, when a liquid collides with a falling surface while falling, the liquid may be divided into a plurality of particles to generate air bubbles. That is, when a tap is turned on, water is filled in a washbasin, and at the same time the air bubbles are generated. Similarly, the source ink may generate the air bubbles while falling into the mixing chamber 313. However, since the source ink has viscosity much higher than that of water or a general ink for printing a 2D object, the air bubbles generated by particle division may not smoothly discharged out of the ink. Thus, when the ink is supplied into the mixing tank 313, it is necessary to minimize generation of air bubbles. Thus, the ink may not fall from the top surface of the mixing chamber but be introduced into the mixing chamber 313 while flowing along the supply passage 314.

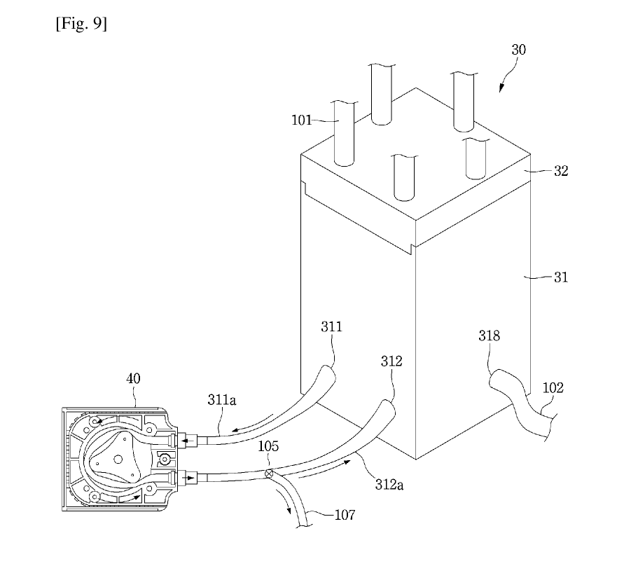

FIG. 9 is a view illustrating the ink mixing mechanism of the 3D printing apparatus according to an embodiment.

Referring to FIG. 9, the 3D printing apparatus 10 according to an embodiment may mix inks having colors such as red, blue, green, and yellow colors to generate inks having new colors. The inks having new colors may be supplied into the head unit 22 and sprayed from the head unit 22.

The first supply tube 101 is connected to the source supply port 321 and the cleaning solution supply port 322 of the tank cover 32. Also, the first supply tube 101 connected to the cleaning solution supply port 322 may be connected to a cleaning solution tank disposed together with the source tanks. Alternatively, the cleaning solution tank may be disposed at a separate position distinct from positions of the source tanks.

In detail, in addition to that the agitator 317 is disposed in the mixing tank 30 to mix the inks, the circulation pump 40 may be connected to the outside of the mixing tank 30 to allow the inks to be mixed while circulating. Then, a mixing rate of the ink may increase to uniformly mix the inks having various colors.

In more detail, a return tube 312a is connected to the return port 312 of the mixing tank 30. The return tube 312a has an inlet end that is connected to an outlet end of the circulation pump 40.

According to the structure, a circulation operation in which a portion of the ink mixed in the mixing chamber 313 flows out of the circulation pump 40 and then returns again into the mixing chamber and an agitating operation in which the ink is mixed by the agitator 317 may be simultaneously performed.

A 3-way valve 105 is disposed in one portion of the return tube 312a. A cleaning solution discharge tube 107 is connected to the 3-way valve 105.

In detail, if it is necessary to spray a mixed ink having a color different from that of the mixed ink generated in the mixing tank 30, a process in which all of the pre-generated mixed inks are thrown away, and then inks are received and mixed from the source tank 26 has to be newly performed.

Also, it is necessary to throw all of the remaining inks in the mixing chamber 313, the ink circulation passage, and the head unit 22 away and clean the mixing chamber 313, the ink circulation passage, and the head unit 22 so as to prevent an ink having a color different from a desired color from being generated by mixing the pre-generated ink with an ink having a new color.

For this, the ink remaining in the mixing chamber 313 is discharged to the outside of the printing apparatus through the circulation pump 40 and the cleaning solution discharge port 107. Also, the cleaning solution is introduced into the cleaning solution supply port 322. The cleaning solution may be a transparent volatile solvent, but the present disclosure is not limited thereto. For example, the cleaning solution may be a solvent having good surface-active performance that is capable of washing off the source ink.

When a predetermined amount of cleaning solution is supplied into the mixing chamber 313, the circulation pump 40 and the agitator 317 may operate to allow the cleaning solution to flow into the mixing chamber 313, the discharge tube 311a, the return tube 312a, and the circulation pump 40.

Then, the cleaning solution circulates for a predetermined time, and the 3-way valve 105 is switched to allow a mixed fluid of the cleaning solution and the ink to flow into the cleaning solution discharge tube 107. This process may be repeatedly performed for a predetermined number of times or a predetermined time to clean a mixing passage.

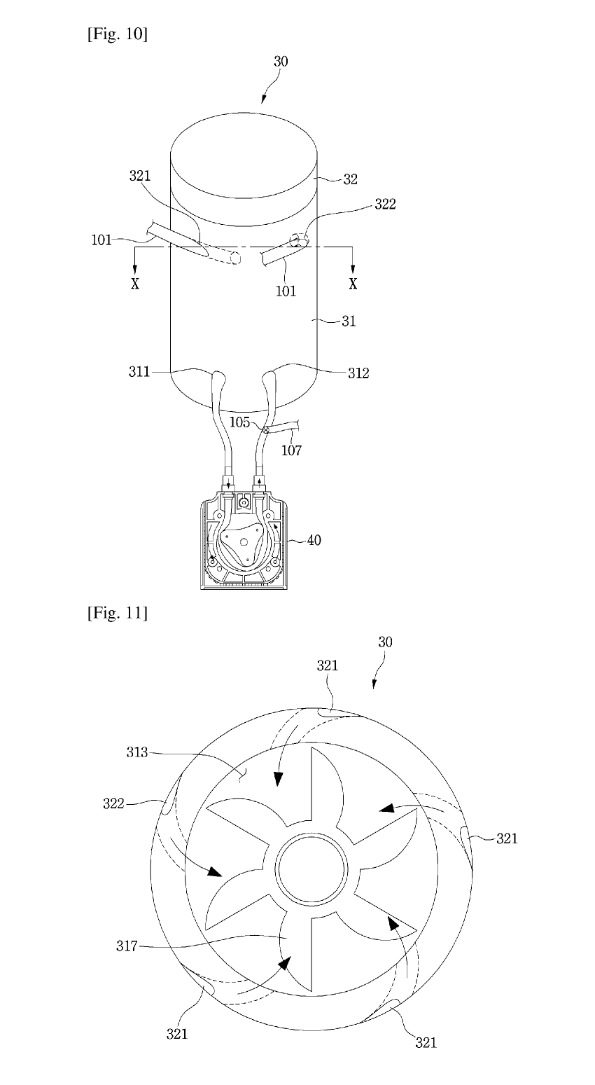

FIG. 10 is a view illustrating an ink mixing mechanism including a mixing tank according to another embodiment, and FIG. 11 is a cross-sectional view cut off along line XI-XI of FIG. 10.

Referring to FIGS. 10 and 11, the mixing tank 30 according to the current embodiment has a cylindrical shape. The ink or the cleaning solution supplied from the source tank may be supplied in a side surface of the mixing tank 30 in a spiral shape. Since other ink circulation structures are the same as those of the foregoing embodiment, repeated descriptions thereof will be omitted.

In detail, the plurality of supply ports 321 and the cleaning solution supply port 322 are disposed along the side surface of the mixing tank 30. The supply passage 314 spirally extends toward the bottom surface of the mixing tank 30 and is connected to the mixing chamber 313.

Like this, when the ink is supplied along the spirally extending supply passage 314, the plurality of inks discharged from the supply passage 314 may fall while spirally rotating along an inner circumferential surface of the mixing chamber 313 by a inertial force and thus be mixed with each other. As a result, the inks may increase in mixing rate by a vortex.

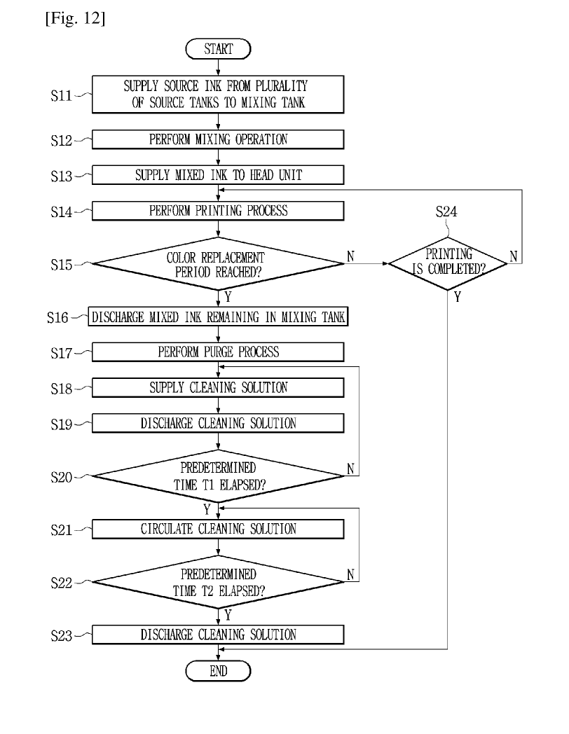

FIG. 12 is a flowchart showing a mixing tank cleaning process for changing an ink color in the mixing tank.

Referring to FIG. 12, as described above, in operation S11, the source ink is supplied from the plurality of source tanks 26 into the mixing tank. Then, in operation S12, when the source ink is completely supplied into the mixing tank, a mixing process is performed.

In detail, in the mixing process, an ink agitating operation in which the agitator 317 in the mixing tank 30 rotates and an ink circulation operation in which the ink circulates between the mixing tank 30 and the circulation pump 40 through the circulation pump 40 may be simultaneously performed. The mixing process may be performed for a predetermined time.

When the ink mixing process is completed, and the ink having the desired new color is generated, in operation S13, the mixed ink is supplied to the head unit 22. In operation S14, the ink is sprayed to a build tray 13 through the head unit 22, and a 3D printing work is performed. In operation S15, a control unit of the 3D printing apparatus 10 determines whether the ink reaches a color replacement time.

If the control unit determines that although the ink reaches the color replacement time, the printing is completed, or a printing interruption reason is generated, the printing work is completed. Meanwhile, in operation S24, when it is determined that the ink does not reach the color replacement time, and the printing completion or the printing interruption reason is not generated, the printing process in the operation S14 is continuously performed.

In detail, in operation S16, when the control unit determines that the ink reaches to the color replacement time, the mixed ink remaining in the mixing tank is discharged. Here, since the ink remaining in the head unit 22 has to be discharged together with the mixed ink, in operation S17, a purge process performed in a nozzle cleaning process is performed. The purge process is a process in which air is blown into the head unit 22 at a high pressure to discharge ink remaining in the head unit 22 through the nozzle.

Also, to discharge the remaining ink in the mixing tank 30, the ink is discharged to the circulation pump 40 through the discharge tube 311a in a state where supply of the ink to the second supply tube 102 is stopped. In the ink discharge process, the circulation pump 40 may act as a discharge pump having an ink discharge function instead of the ink circulation function.

In detail, in the process in which the ink is discharged to the circulation pump 40, the 3-way valve 105 disposed in the return tube 312a is adjusted in an opening degree to guide the ink to the cleaning solution discharge tube 107. Thus, the remaining ink discharged through the discharge tube 311a is discharged outside the printing apparatus through the cleaning solution discharge tube 107.

When the mixed ink remaining in the mixing tank is completely discharged, in operation S18, the cleaning solution is supplied into the mixing tank 30 to clean the passage on which the ink is stained. The cleaning solution may be supplied into the mixing tank 30 through the cleaning solution supply tube connected to the cleaning solution supply port 322.

Also, the supplied cleaning solution is discharged to the outside through the cleaning solution discharge tube 107. That is, the 3-way valve maintains an inlet end of the cleaning solution discharge tube 107 in an opened state. Then, the ink stained on an inner wall of each of the mixing tank 30, the discharge tube 311a, and the circulation pump 40 may be firstly discharged to the outside.

Like this, the cleaning solution supply process in the operation S18 and a cleaning solution discharge process in operation S19 are performed for a predetermined time T1, and in operation S20, it is determined that the remaining ink is somewhat discharged, in operation S21, a cleaning solution circulation process is performed.

In detail, when the cleaning solution circulation process is started, the 3-way valve 105 is adjusted in the opening degree to close the inlet end of the cleaning solution discharge tube 107 and open the return tube 312a. Then, the cleaning solution is supplied into the mixing tank 30 to circulate between the mixing tank 30 and the circulation pump 40 by an operation of the circulation pump 40. Then, in operation S22, when it is determined that a predetermined time T2 elapses, the 3-way valve 105 is adjusted in the opening degree to discharge the cleaning solution to the outside through the cleaning solution discharge tube 107.

Like this, when the process for cleaning the mixing tank 30 is completed, the inks are supplied from the source tanks 26 to the mixing tank 30, and a process for generating an ink having a new color is performed.

Since the mixing tank 30 is separately provided between the source tank 26 and the head unit 22, all of the printing heads constituting the head unit 22 simultaneously operate to reduce the printing time and extend a lifespan of the head unit 22.

1. A three-dimensional (3D) printing apparatus comprising:
a plurality of source to store gel-phase source inks having specific colors;
a build tray on which a building object is to be printed;
a head device including a plurality of printing heads to spray the source inks onto the build tray;
a mixing tank coupled between the source tanks and the head device, the mixing tank to mix the source inks from the plurality of source tanks;
a first supply tube to couple at least one of the plurality of source tanks to the mixing tank; and
a second supply tube to couple the mixing tank to the head device.

2. The 3D printing apparatus according to claim 1, wherein the first supply tube comprises:
a plurality of ink supply tubes to couple the plurality of source tanks to the mixing tank, and to allow the source inks to flow to the mixing tank; and
a cleaning solution supply tube allow a cleaning solution to flow.

3. The 3D printing apparatus according to claim 2, further comprising a cleaning solution supply tank to couple to an inlet end of the cleaning solution supply tube.

4. The 3D printing apparatus according to claim 2, wherein the mixing tank includes:
a tank body having at least a wall to form a mixing chamber;
a tank cover at a top of the tank body; and
an agitator in the mixing chamber to mix the inks.

5. The 3D printing apparatus according to claim 4, wherein the mixing tank includes:
a plurality of ink supply ports at the tank body or the tank cover, wherein an outlet end of each of the plurality of ink supply tubes is coupled to a corresponding one of the ink supply ports;
a cleaning supply port at the tank body or the tank cover, wherein an outlet end of the cleaning solution supply tube is coupled to the cleaning supply port; and
a plurality of supply passages to couple the ink supply ports to the mixing chamber and to couple the cleaning supply port to the mixing chamber.

6. The 3D printing apparatus according to claim 5, wherein the plurality of supply passages are provided at the wall of the tank body and are spaced from the mixing chamber, and the supply passages to communicate with the mixing chamber.

7. The 3D printing apparatus according to claim 4, wherein the mixing includes:
a discharge port at a side of the tank body;
a discharge passage coupling the discharge port to the mixing chamber;
a return port at a side of the tank body; and
a return passage coupling the return port to the mixing chamber.

8. The 3D printing apparatus according to claim 7, comprising:
a discharge tube coupled to the discharge port;
a return tube coupled to the return port; and
a circulation pump having an inlet and an outlet, wherein the inlet of the circulation pump is coupled to the discharge tube, and the outlet of the circulation pump is coupled to the return tube, wherein the circulation pump to circulate the inks in the mixing tank.

9. The 3D printing apparatus according to claim 8, comprising:
a cleaning solution discharge tube coupled to the return tube at a prescribed position of the return tube; and
a 3-way valve at the prescribed position,
wherein the ink or cleaning solution discharged from the circulation pump flows in one of the return tube and the cleaning solution discharge tube based on the 3-way valve.

10. A three-dimensional (3D) printing apparatus comprising:
a plurality of source tanks to store source inks;
a head device having a plurality of printing heads to spray the source inks onto a build tray;
a mixing tank coupled between the source tanks and the head device;
a plurality of first supply tubes coupled between the mixing tank and separate corresponding ones of the plurality of source tanks; and
a second supply tube coupled between the mixing tank and the head device to supply ink from the mixing tank to the head device.

11. The 3D printing apparatus according to claim 10, comprising:
a cleaning solution supply tube to allow a cleaning solution to flow to the mixing tank.

12. The 3D printing apparatus according to claim 11, comprising a cleaning solution supply tank coupled to one end of the cleaning solution supply tube.

13. The 3D printing apparatus according to claim 11, wherein the mixing tank includes:
a tank body having a mixing chamber to receive the inks;
a tank cover at a top of the tank body; and
an agitator in the mixing chamber, the agitator to mix the source inks in the mixing chamber.

14. The 3D printing apparatus according to claim 13, wherein the mixing tank includes:
an plurality of ink supply ports at the mixing tank, wherein an end of each of the plurality of ink supply tubes is coupled to a corresponding one of the ink supply ports;
a cleaning supply port at the mixing tank, wherein an end of the cleaning solution supply tube is coupled to the cleaning supply port; and
a plurality of supply passages to couple the ink supply ports to the mixing chamber and to couple the cleaning supply port to the mixing chamber.

15. The 3D printing apparatus according to claim 14, wherein the plurality of supply passages are at a wall of the tank body and are spaced from the mixing chamber.

16. The 3D printing apparatus according to claim 13, wherein the mixing tank includes:
a discharge port at the tank body;
a discharge passage coupling the discharge port to the mixing chamber;
a return port at the tank body; and
a return passage coupling the return port to the mixing chamber.

17. The 3D printing apparatus according to claim 16, comprising:
a discharge tube coupled to the discharge port;
a return tube coupled to the return port; and
a circulation pump having an inlet and an outlet, wherein the inlet of the circulation pump is coupled to the discharge tube, and the outlet of the circulation pump is coupled to the return tube, wherein the circulation pump to circulate the inks in the mixing tank.

18. The 3D printing apparatus according to claim 17, comprising:
a cleaning solution discharge tube coupled to the return tube at a prescribed position of the return tube; and
a 3-way valve at the prescribed position,
wherein the ink or cleaning solution discharged from the circulation pump flows in one of the return tube and the cleaning solution discharge tube based on the 3-way valve.

19. A three-dimensional (3D) printing apparatus comprising:
a plurality of source tanks to store source inks;
a plurality of printing heads to spray the source inks onto a tray;
a mixing tank coupled between the source tanks and the head device, the mixing tank to mix the source inks from the plurality of source tanks, wherein the mixing tank includes a mixing chamber and an agitator to mix the inks in the mixing chamber;
a plurality of first supply tubes coupled between the mixing tank and separate corresponding ones of the plurality of source tanks; and
a second supply tube coupled between the mixing tank and the printing heads to supply ink from the mixing tank to the printing heads.

20. The 3D printing apparatus according to claim 19, comprising a circulation pump to circulate the inks in the mixing tank
